(19) United States
(12) Patent Application Publication
(10) Pub. No.: US 2009/0081901 A1
(43) Pub. Date: Mar. 26, 2009

(54) Cable connector, method of connecting a cable connector and a cable

(75) Inventors: Katsuhiko Nakazawa, Tokyo (JP); Masahiro Yamauchi, Tokyo (JP)

Correspondence Address: COLLARD & ROE, P.C., 1077 NORTHERN BOULEVARD, ROSLYN, NY, 11576, US

(73) Assignee: Japan Aviation Electronics Industry, Limited

(21) Appl. No.: 12/220,048

(22) Filed: Jul. 21, 2008

(30) Foreign Application Priority Data
Sep. 21, 2007 (JP) 2007-245484

(51) Int. Cl. H01R 13/62; H01R 13/58

(52) U.S. Cl. 439/465; 439/889

(57) ABSTRACT

A cable connector 1 includes a cover insulator adapted to clamp a cable. The cable has an end portion bent by a bending angle α. The cover insulator is coupled to a base insulator. The base insulator holds a terminal having an end portion bent by a bending angle β. Herein, the angles α and β satisfy the relationship given by β<π−α(rad) so that the end portion of the cable is pressed by the end portion of the terminal.

This application is based upon and claims the benefit of priority from Japanese patent application No. 2007-245484, filed on Sep. 21, 2007, the disclosure of which is incorporated herein in its entirety by reference.

### BACKGROUND OF THE INVENTION

The present invention relates to a cable connector and a method of connecting a cable connector and a cable.

For installation of electrical equipment in transport machines such as automobiles, computer wiring, and the like, cables having a variety of structures are used. Generally, cable connectors for connection between cables are provided.

For example, a cable connector comprises a cover insulator adapted to clamp an end portion of a cable and a base insulator having a terminal (contact) to be connected to another connector as a mating connector.

With this structure, the cable connector and the cable are connected by coupling the cover insulator and the base insulator and connecting the end portion of the cable and the terminal of the cable connector.

As a method of connecting the end portion of the cable and the terminal of the cable connector, a connecting method using a solder is known, for example, as described in Japanese Unexamined Patent Application Publication (JP-A) No. 2004-192817 (Patent Document 1).

Specifically, as described in Patent Document 1, a central conductor (at the end portion of a cable) and the terminal are connected by the solder.

However, in the connecting method mentioned above, variation in an amount of the solder results in variation in cross sectional area of a connecting portion. In this event, impedance mismatch may be caused during high-speed transmission.

In view of the above, development is made of a connecting method using so-called laser welding. In this method, the cable is connected to the terminal by irradiating a laser beam directly to the connecting portion to melt the connecting portion.

In this case, the end portion of the cable and the terminal must be brought into tight contact with each other in advance. For this purpose, use is made of a structure in which the end portion of the cable and the terminal are pressed by an additional fixing member to be brought into tight contact with each other.

For example, Japanese Unexamined Patent Application Publication (JP-A) No. H07-211405 (Patent Document 2) discloses a connector having a structure in which a conductor at an end portion of a cable and a connecting terminal are pressed by an elastic member integrally formed with a housing portion.

### SUMMARY OF THE INVENTION

However, in the above-mentioned structure, the cable connector has a complicated structure because the elastic member is required.

Furthermore, the elastic member is arranged so as to bring the cable into contact with the terminal. Thus, an irradiation direction of the laser beam is undesirably limited by the elastic member.

In view of the above-mentioned problems, it is an object of this invention to provide a cable connector in which a connecting portion has a simple structure and an irradiation direction of a laser beam is not limited.

It is also another object of this invention to provide a method of connecting a cable connector and a cable in which an irradiation direction of a laser beam is not limited.

According to the first invention, there is provided a cable connector comprising a cover insulator for holding an end portion of a cable, a base insulator coupled to the cover insulator, and a terminal held on the base insulator and adapted to be connected to another connector and the cable, the cover insulator having holding unit holding the end portion of the cable, the terminal having an end portion held in a shape adapted to press the end portion of the cable when the cover insulator and the base insulator are coupled to each other, the cable connector being connected to the cable by coupling the cover insulator and the base insulator to each other and connecting the terminal to the end portion of the cable by laser welding.

According to the second invention, there is provided a method of connecting a cable connector and a cable, the cable connector comprising a cover insulator for holding an end portion of the cable; a base insulator coupled to the cover insulator, and a terminal held on the base insulator and adapted to be connected to another connector and the cable; the method comprising, (a) bending the end portion of the cable, (b) bending an end portion of the terminal into a shape adapted to press the end portion of the cable when the cover insulator and the base insulator are coupled to each other, (c) coupling the cover insulator and the base insulator to each other; and (d) connecting the end portion of the cable and the end portion of the terminal by laser welding.

In the first and the second inventions, the cable connector comprises the cover insulator holding the cable, the base insulator to be coupled to the cover insulator, and the terminal held on the base insulator. In the cable connector, the cable and the terminal are bent by bending angles determined so that the end portion of the terminal can press the end portion of the cable when the cover insulator and the base insulator are coupled to each other.

Therefore, an additional elastic member or the like for bringing the end portion of the cable and the terminal into tight contact with each other is not required so that the cable connector has a simple structure.

Since the elastic member or the like is not required, an irradiation direction of a laser beam is not limited during laser welding.

According to the first invention, it is possible to provide a cable connector in which a connecting portion has a simple structure and an irradiation direction of a laser beam is not limited.

According to the second invention, it is possible to provide a method of connecting a cable connector and a cable in which an irradiation direction of a laser beam is not limited.

### BRIEF DESCRIPTION OF THE DRAWINGS

FIG. 1 is a perspective view showing a cable connector;

FIG. 2 is an exploded perspective view of the cable connector illustrated in FIG. 1 but without an insulating member;

FIG. 3A is an enlarged sectional view taken along a line 3A-3A in FIG. 1, with a cable and terminals shown by a side view;

FIG. 3B is an enlarged sectional view, similar to FIG. 3A, for describing a method of connecting another connector to the cable connector;

FIG. 4 is a partially-cutaway perspective view of the cable illustrated in FIG. 2;

FIG. 5 is an enlarged perspective view, partially in section, of a part of the cable connector illustrated in FIG. 2;

FIG. 6 is an enlarged perspective view, partially in section, of a part of a cover insulator illustrated in FIG. 2;

FIG. 7 is a view showing the cover insulator illustrated in FIG. 3A;

FIG. 8 is a view showing a base insulator illustrated in FIG. 3A; and

FIGS. 9 to 11 are sectional views for describing methods of connecting the cable connector and the cable to each other.

### DESCRIPTION OF THE EXEMPLARY EMBODIMENT:

Now, an exemplary embodiment of this invention will be described in detail with reference to the drawing.

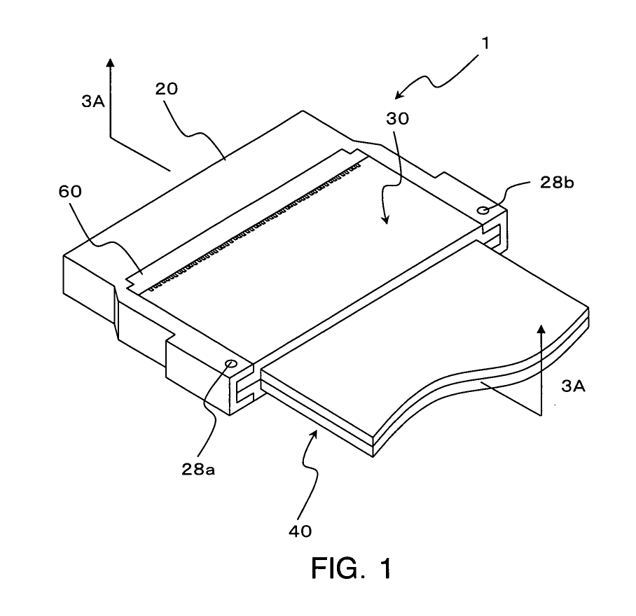

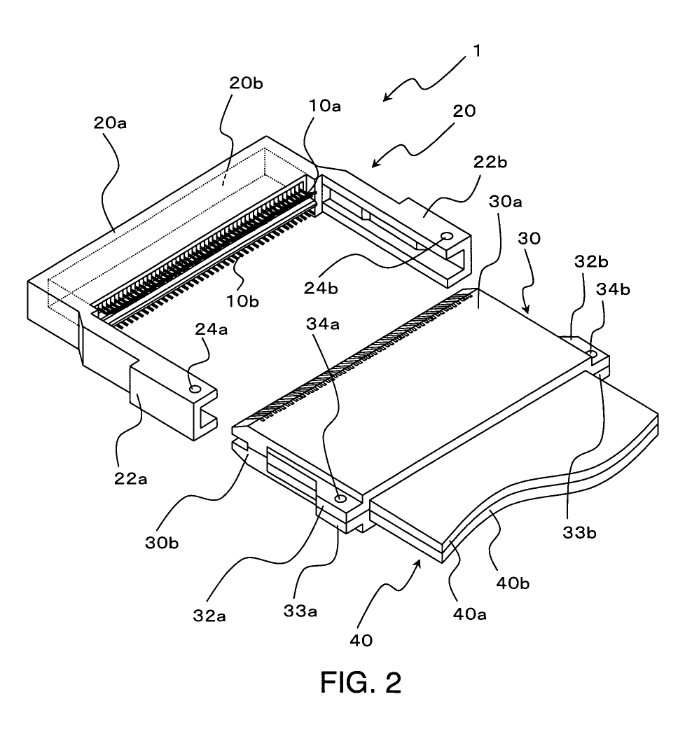

At first referring to FIGS. 1 and 2, description will be made about a schematic structure of a cable connector 1 according to this embodiment.

Herein, as the cable connector 1, a cable connector for a flat cable is illustrated by way of example.

As shown in FIGS. 1 and 2, the cable connector 1 comprises a cover insulator 30, a base insulator 20, and a plurality of terminals 10a and 10b.

The cover insulator 30 is adapted to clamp a cable 40. Thus, the cover insulator 30 is a member for holding an end portion of the cable 40.

The base insulator 20 is adapted to be connected to another connector as a mating connector 81. The base insulator 20 is coupled to the cover insulator 30 so as to surround the cover insulator 30. The base insulator 20 holds the terminals 10a and 10b.

An insulating member 60 is filled between the base insulator 20 and the cover insulator 30 as will later be described in detail.

Next referring to FIGS. 1 to 8, description will be made in detail about structures of the cable 40, the cover insulator 30, and the base insulator 20.

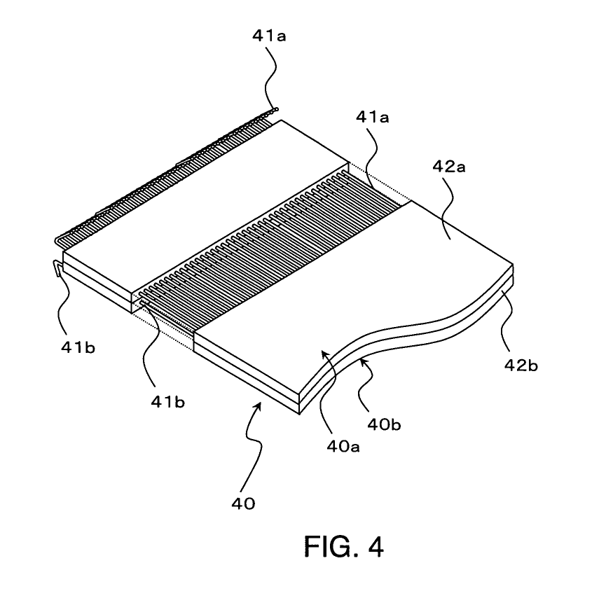

At first referring to FIGS. 2 to 4, the structure of the cable 40 will be described. As shown in FIGS. 2 to 4, the cable 40 is a so-called flat cable and comprises two cables, that is, a first cable 40a and a second cable 40b. As shown in FIG. 4, the first cable 40a has a plurality of conductive core wires 41a. Similarly, the second cable 40b has a plurality of conductive core wires 41b. The core wires 41a are covered with an insulation coating 42a. Similarly, the core wires 41b are covered with an insulation coating 42b.

As will later be described in detail, the first and the second cables 40a and 40b have end portions where the core wires 41a and 41b are exposed. The end portions (the core wires 41a and 41b) of the first and the second cables 40a and 40b are bent and held at a predetermined bending angle α.

Next referring to FIGS. 2, 3A, 3B, and 5 to 7, the structure of the cover insulator 30 will be described.

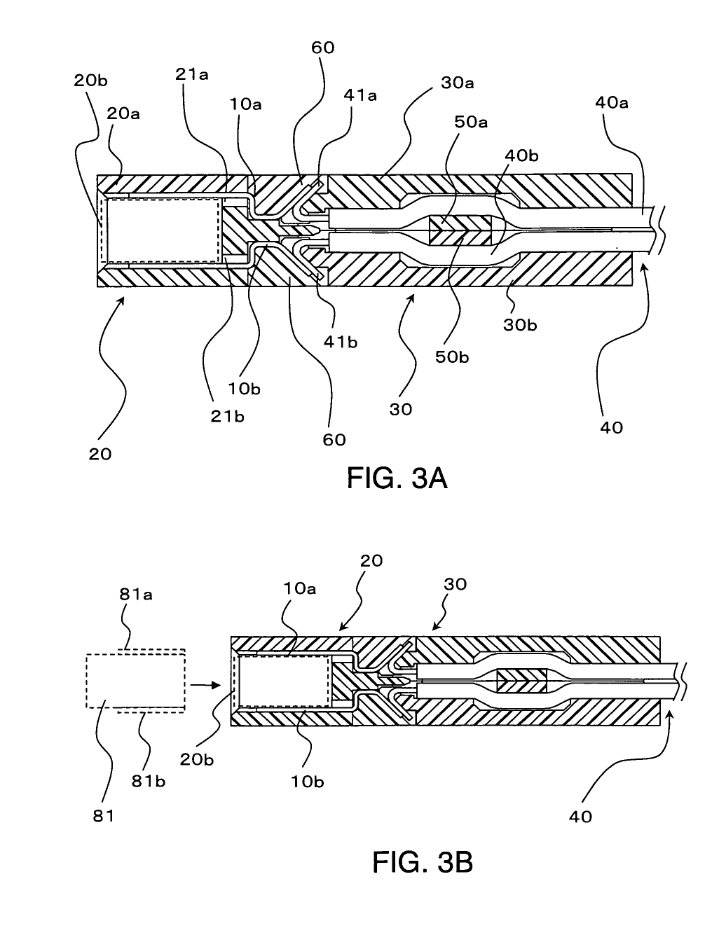

As shown in FIGS. 2, 3A and 3B, the cover insulator 30 comprises covers 30a and 30b faced to each other so as to clamp the end portion of the cable 40.

As shown in FIG. 2, the cover 30a has a pair of side surfaces provided with projections 32a and 32b to be engaged with the base insulator 20 upon coupling, respectively. Similarly, the cover 30b has a pair of side surfaces provided with projections 33a and 33b, respectively. The projections 32a and 32b are provided with holes 34a and 34b adapted to receive pins 28a and 28b (which will later be described), respectively. When the cover insulator 30 is coupled to the base insulator 20, the pins 28a and 28b are press-fitted into the holes 34a and 34b to fix the cover insulator 30 and the base insulator 20 to each other. Although not illustrated in the figure, the projections 33a and 33b are provided with similar holes 35a and 35b. The covers 30a and 30b are arranged in the manner such that the holes 34a and 35a are overlapped with each other and that the holes 34b and 35b are overlapped with each other.

As shown in FIG. 3A, the cover 30a has a plate-like clamp 50a faced to an inner surface thereof which is in contact with the first cable 40a. The cover 30a and the clamp 50a clamp the end portion of the first cable 40a to hold the end portion of the first cable 40a.

Similarly, the cover 30b has a plate-like clamp 50b faced to an inner surface thereof which is in contact with the second cable 40b. The cover 30b and the clamp 50b clamp the end portion of the second cable 40b to hold the end portion of the second cable 40b.

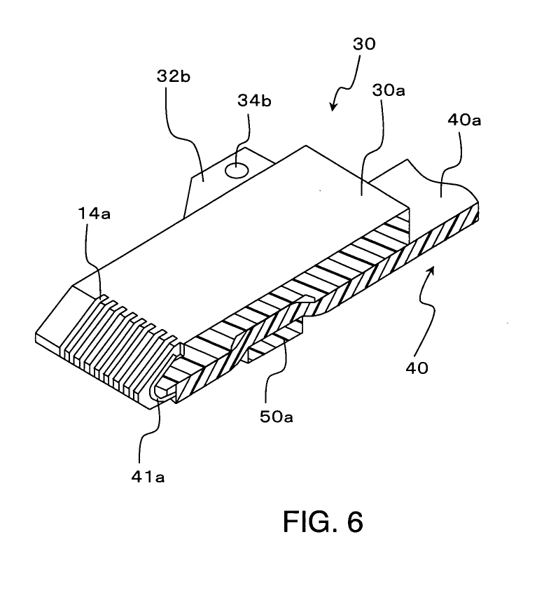

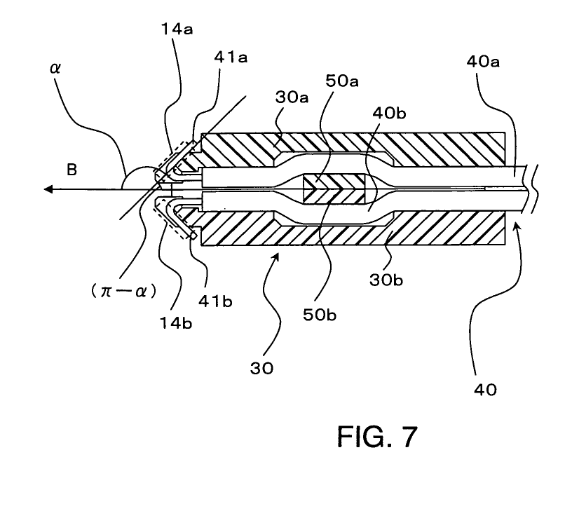

As shown in FIGS. 6 and 7, the cover 30a has an end portion provided with a plurality of grooves 14a as a holding unit. The core wires 41a exposed at the end portion of the first cable 40a are bent and inserted into the grooves 14a, respectively.

As shown in FIG. 7, the grooves 14a are inclined by an inclination angle (π−α) with respect to a coupling direction B along which the cover insulator 30 and the base insulator 20 are coupled to each other. Thus, the grooves 14a serve to hold the core wires 41a bent by the predetermined bending angle α with respect to the coupling direction B.

As shown in FIG. 7, the cover 30b has an end portion provided with a plurality of grooves 14b as a holding unit. The grooves 14b correspond in shape to the core wires 41b.

The core wires 41b exposed at the end portion of the second cable 40b are bent and inserted into the grooves 14b, respectively.

The grooves 14b are inclined by an inclination angle (π−α) with respect to the coupling direction B. Thus, the grooves 14b serve to hold the core wires 41b bent by the predetermined bending angle α (not shown).

Next referring to FIGS. 1, 2, 3A, 3B, and 8, the structure of the base insulator 20 will be described in detail.

As shown in FIGS. 2, 3A, 3B and 8, the base insulator 20 has a main body 20a. The main body 20a has a recessed portion 20b formed at its front surface on the side fitted to the mating connector 81 (which will later be described). The recessed portion 20b is adapted to receive the mating connecter 81 inserted therein. The main body 20a has a pair of U-shaped portions 22a and 22b formed at both ends of its rear surface opposite to the front surface provided with the recessed portion 20b. The U-shaped portions 22a and 22b are adapted to be engaged with the projections 32a, 32b, 33a, and 33b when the base insulator 20 is coupled to the cover insulator 30.

In the state illustrated in FIG. 1, the U-shaped portion 22a is engaged with the projections 32a and 33a while the U-shaped portion 22b is engaged with the projections 32b and 33b.

The U-shaped portions 22a and 22b are provided with holes 24a and 24b, respectively. The holes 24a and 24b are adapted to receive the pins 28a and 28b (which will later be described) press-fitted therein when the cover insulator 30 and the base insulator 20 are coupled to each other.

In the state illustrated FIG. 1, the pin 28a is press-fitted into the holes 24a, 34a, and 35a while the pin 28b is press-fitted into the holes 24b, 34b, and 35b. Thus, the cover insulator 30 and the base insulator 20 are fixed to each other by the pins 28a and 28b.

As shown in FIG. 3A, the main body 20a has an inner wall provided with a plurality of terminal holding portions 21a and 21b which penetrate through the inner wall to protrude from the rear surface opposite to the front surface provided with the recessed portion 20b.

The terminal holding portions 21a and 21b hold the terminals 10a and 10b, respectively. The terminals 10a and 10b are equal in number to the core wires 41a and 41b, respectively. The terminals 10a are connected to the core wires 41a and a plurality of terminals 81a (which will later be described) of the mating connector 81. The terminals 10b are connected to the core wires 41b and a plurality of terminals 81b (which will later be described) of the mating connector 81.

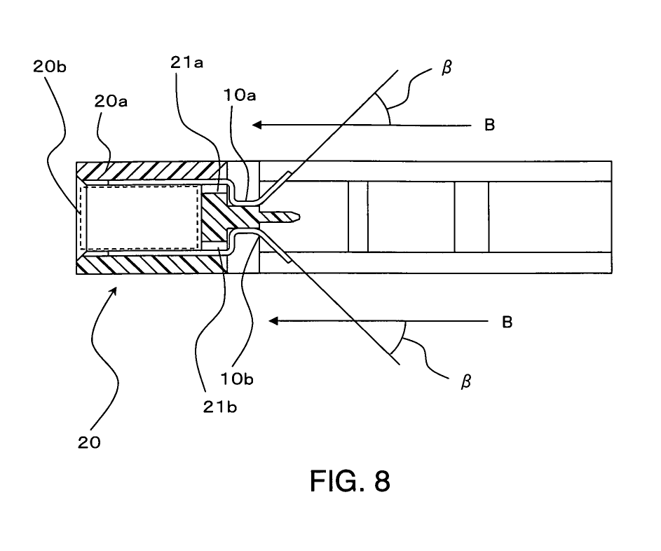

As shown in FIG. 8, the terminals 10a and 10b have end portions held in a shape adapted to press the core wires 41a and 41b exposed at the end portion of the cable 40 when the cover insulator 30 and the base insulator 20 are coupled to each other.

Specifically, the end portions of the terminals 10a and 10b are bent and held at a bending angle β with respect to the coupling direction B in the state where the terminals 10a and 10b are not brought into contact with the cable 40

Herein, the angles α and β satisfy the relationship given by:

β<π−α(rad) (1)

By setting the angles α and β satisfying the above-mentioned relationship, the core wires 41a and 41b are pressed by the end portions of the terminals 10a and 10b when the cover insulator 30 and the base insulator 20 are coupled to each other. Therefore, the end portions of the terminals 10a and 10b come into tight contact with the core wires 41a and 41b.

Thus, in this embodiment, the end portions of the terminals 10a and 10b serve as an elastic member. Therefore, an additional elastic member or the like for bringing the end portions of the terminals and the core wires into tight contact with each other is not required.

Herein, in the cable connector 1, the end portions of the terminals 10a and 10b are connected to the core wires 41a and 41b by laser welding which will later be described. Since the elastic member or the like is not required as described above, an irradiation direction of a laser beam is not limited during laser welding.

As shown in FIG. 3A, in the cable connector 1, the end portions of the terminals 10a and 10b and the core wires 41a and 41b are covered with the insulating member 60.

Now, description will briefly be made about a method of connecting the cable 40 connected to the cable connector 1 to another cable as a mating cable or a substrate.

In case where the cable 40 connected to the cable connector 1 is electrically connected to the mating cable or the substrate, the mating connector 81 connected to the mating cable or the substrate is inserted into the recessed portion 20b of the base insulator 20, as shown in FIG. 3B. Then, the terminals 10a and 10b are connected to the terminals 81a and 81b of the mating connector 81. Consequently, the cable 40 is electrically connected to the mating cable or the substrate via the terminals 10a and 10b and the terminals 81a and 81b of the mating connector 81.

Next referring to FIGS. 2, 3A, 3B, 5, and 9 to 11, description will be made about a method of connecting the cable connector 1 to the cable 40.

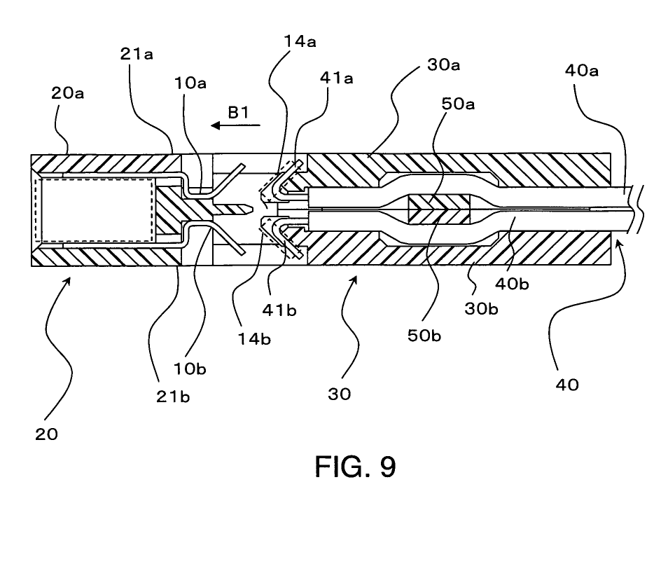

At first referring to FIG. 9, the cable 40 is combined with the cover insulator 30. Specifically, the first and the second cables 40a and 40b are combined with the covers 30a and 30b, respectively, and the core wires 41a and 41b are inserted into the grooves 14a and 14b, respectively.

By inserting the core wires 41a and 41b into the grooves 14a and 14b, the core wires 41a and 41b at the end portion of the first and the second cables 40a and 40b are bent and held at the bending angle α.

Thereafter, the covers 30a and 30b are combined with each other.

Furthermore, the terminals 10a and 10b are combined with the cover insulator 30 and the end portions of the terminals 10a and 10b are bent and held at the bending angle β.

Next, the cover insulator 30 is moved in a direction depicted by an arrow B1 in FIG. 9 and inserted into the base insulator 20.

At this time, the cover insulator 30 is inserted into the base insulator 20 in the manner such that the projections 32a and 33a and the projections 32b and 33b of the cover insulator 30 are engaged with inner walls of the U-shaped portions 22a and 22b of the base insulator 20, respectively (see FIG. 2).

By inserting the cover insulator 30 in the above-mentioned manner, the coupling direction is limited to the direction depicted by the arrow B1 in FIG. 9. Consequently, positioning is accurately carried out.

When the cover insulator 30 is moved to a position where the holes 24a and 24b of the base insulator 20 are coincident with the holes 34a, 34b, 35a, and 35b of the cover insulator 30, insertion is stopped.

Then, the pin 28a is press-fitted into the holes 24a, 34a, and 35a while the pin 28b is press-fitted into the holes 24b, 34b, and 35b so that the cover insulator 30 is fixed to the base insulator 20.

As described above, the cover insulator 30 and the base insulator 20 are coupled to each other.

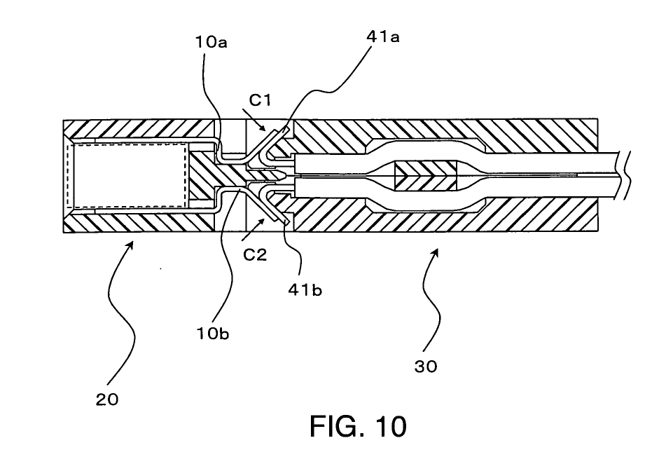

In the above-mentioned state, the end portions of the terminals 10a and 10b are brought into contact with the core wires 41a and 41b, respectively, as shown in FIG. 10. At this time, the angles α and β satisfy the relationship given by the inequality (1). Therefore, the end portions of the terminals 10a and 10b press the core wires 41a and 41b in directions depicted by arrows C1 and C2 so that the end portions of the terminals 10a and 10b are brought into tight contact with the core wires 41a and 41b, respectively.

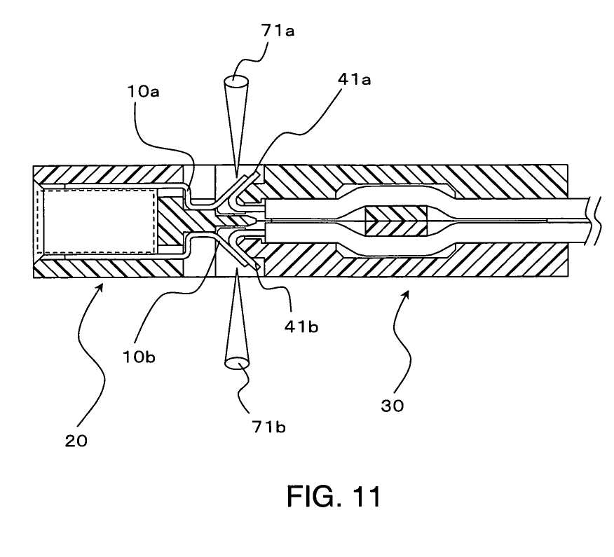

Next referring to FIG. 11, laser beams 71a and 71b are irradiated to areas where the end portions of the terminals 10a and 10b are brought into contact with the core wires 41a and 41b to perform laser welding. Thus, the end portions of the terminals 10a and 10b are connected to the core wires 41a and 41b to form connecting portions.

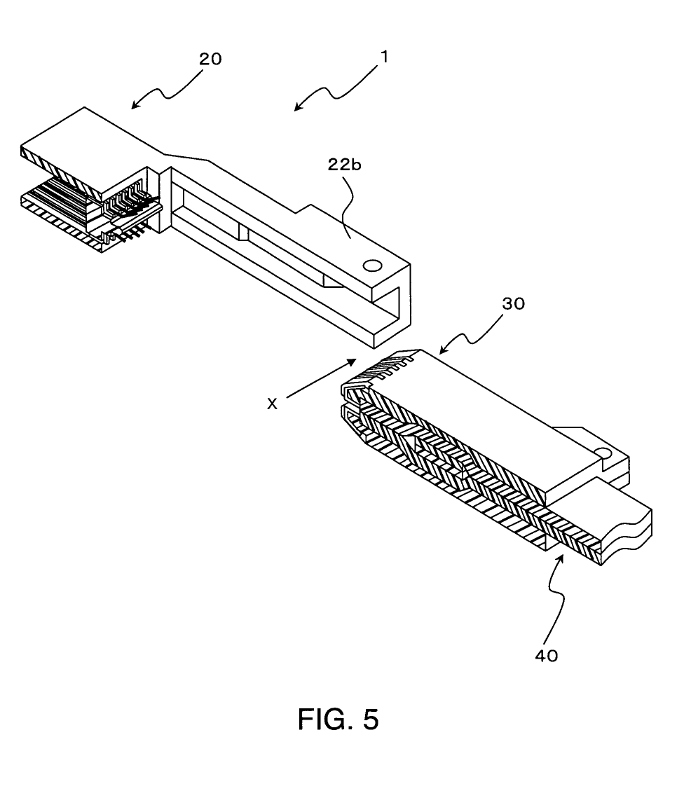

At this time, the cover insulator 30 and the base insulator 20 are moved in a direction X in FIG. 5 in cooperation with oscillation of the laser beams 71a and 71b so that the end portions of all the terminals 10a and 10b are connected to the core wires 41a and 41b.

Herein, the end portions of the terminals 10a and 10b serve as an elastic member. Accordingly, the additional elastic member or the like for bringing the end portions of the terminals and the core wires into tight contact with each other is not required.

Therefore, irradiation directions of the laser beams 71a and 71b are not limited.

When the welding is finished, the connecting portions of the end portions of the terminals 10a and 10b and the core wires 41a and 41b connected by laser welding are covered with the insulating member 60 in order to assure environment resistance (in order to prevent adhesion of dirt, dust, and the like) (see FIG. 3A).

By the above-mentioned method, the cable connector 1 is connected to the cable 40.

As described above, according to this embodiment, the cable connector 1 comprises the cover insulator 30, the base insulator 20, and the terminals 10a and 10b. The end portions of the terminals 10a and 10b are bent and held at the bending angle β. On the other hand, the core wires 41a and 41b exposed at the end portion of the cable 40 are bent and held at the bending angle α by the grooves 14a and 14b of the cover insulator 30. The angles α and β satisfy the above-mentioned relationship.

Therefore, the core wires 41a and 41b are pressed by the end portions of the terminals 10a and 10b as the elastic member when the cover insulator 30 and the base insulator 20 are coupled to each other. Thus, the end portions of the terminals 10a and 10b come into tight contact with the core wires 41a and 41b, respectively.

Accordingly, an additional elastic member or the like for bringing the end portions of the terminals into tight contact with the core wires is not required. Consequently, the cable connector 1 has a simple structure and irradiation directions of the laser beams 71a and 71b are not limited during laser welding.

Although this invention has been described in conjunction with the exemplary embodiment thereof, this invention may be modified in various other manners within the scope of the appended claims. In the foregoing embodiment, description has been made about the case where this invention is applied to the cable connector for a flat cable. However, this invention is not limited thereto but is also applicable, for example, to cable connectors for cables other than the flat cable.

What is claimed is:

1. A cable connector comprising:
a cover insulator for holding an end portion of a cable;
a base insulator coupled to said cover insulator, and;
a terminal held on said base insulator and adapted to be connected to another connector and said cable;
said cover insulator having holding unit holding the end portion of said cable;
the terminal having an end portion held in a shape adapted to press the end portion of said cable when said cover insulator and said base insulator are coupled to each other;
said cable connector being connected to said cable by coupling said cover insulator and said base insulator to each other and connecting said terminal to the end portion of said cable by laser welding.

2. The cable connector as claimed in claim 1, wherein:
said holding unit holds the end portion of said cable so that said cable is bent and held at a bending angle α with respect to a coupling direction of said cover insulator and said base insulator;
the end portion of said terminal being bent and held at a bending angle β with respect to said coupling direction in the state where the end portion of said terminal is not brought into contact with the end portion of said cable;
said angles α and β satisfying the relationship given by:
β<π−α(rad)

3. The cable connector as claimed in claim 2, wherein:
said holding unit comprises a groove formed at an end portion of said cover insulator and adapted to receive the end portion of said cable inserted therein;
said groove being inclined at an inclination angle π−α(rad) with respect to said coupling direction.

4. The cable connector as claimed in claim 1, further comprising an insulating member covering the end portion of said cable and said terminal.

5. A method of connecting a cable connector and a cable, said cable connector comprising a cover insulator for holding an end portion of said cable; a base insulator coupled to said cover insulator, and a terminal held on said base insulator and adapted to be connected to another connector and said cable; said method comprising:
(a) bending the end portion of said cable;
(b) bending an end portion of said terminal into a shape adapted to press the end portion of said cable when said cover insulator and said base insulator are coupled to each other;
(c) coupling said cover insulator and said base insulator to each other; and
(d) connecting the end portion of said cable and the end portion of said terminal by laser welding.

6. The method as claimed in claim 5, wherein:
said (a) bending the end portion of said cable by a bending angle α with respect to a coupling direction of said cover insulator and said base insulator;
said (b) bending the end portion of said terminal by a bending angle β with respect to said coupling direction;
said angle α and said angle β satisfying the relationship given by:
β<π−α(rad)

7. The method as claimed in claim 6, further comprising:
(e) covering a part connected by laser welding with an insulating member.
